(19) United States
(12) Patent Application Publication
(10) Pub. No.: US 2005/0033568 A1
(43) Pub. Date: Feb. 10, 2005

(54) Methods and systems for extracting synonymous gene and protein terms from biological literature

(76) Inventors: Hong Yu, Bronx, NY (US); Andrey Rzhetsky, New York, NY (US)

Correspondence Address: Leslie Gladstone Restaino;Brown Raysman Millstein Felder & Steiner LLP, 163 Madison Avenue, P.O. Box 1989, Morristown, NJ, 07962-1989, US

(21) Appl. No.: 10/915,168

(22) Filed: Aug. 9, 2004

Related U.S. Application Data
(60) Provisional application No. 60/493,977, filed on Aug. 8, 2003.

(51) Int. Cl. G06F 7/00

(52) U.S. Cl. 704/10

(57) ABSTRACT

The present invention generally provides methods for extracting gene and/or protein synonyms from text by processing a plurality of documents making up a text corpus, tagging a plurality of terms, each term identifying at least one of a gene and a protein from the text corpus, and determining whether at least two of the tagged terms are synonyms identifying a common gene or protein using one or more of expert knowledge or machine learning techniques, including unsupervised, partially supervised, and supervised machine learning techniques.

### RELATED APPLICATION

This application claims the benefit of U.S. Provisional Application No. 60/493,977 entitled EXTRACTING SYNONYMOUS GENE AND PROTEIN TERMS FROM BIOLOGICAL LITERATURE, filed Aug. 8, 2003, which is hereby incorporated herein in its entirety.

### BACKGROUND OF THE INVENTION

The present invention generally relates to data processing systems and methods. More particularly, the invention relates to systems and methods for identifying synonymous terms from text.

Genes and proteins often have multiple names and abbreviations. As biological research progresses, additional names or abbreviations may be given for the same substance, or different names may be found to represent the same substance. For example, the protein lymphocyte associated receptor of death has several synonyms including LARD, Apo3, DR3, TRAMP, wsl, and TrifRSLW12. Authors often use different names to refer to the same gene or protein across articles or sub-domains. Identifying these name variations would benefit information retrieval and information extraction systems. Recognizing the alternate names for the same substance would help biologists to find and use relevant literature.

Many biological databases such as GenBank and SWISSPROT include synonyms; however, these databases may not always be up to date. Additionally, biology experts disagree with some of the synonyms that are listed in the SWISSPROT database. Furthermore, lists of gene and protein synonyms and thesauri are mainly constructed by laborious manual curation and review. Therefore, it is desirable to automate this process due to the increasing number of discovered genes and proteins.

Recent computational linguistics research on synonym detection has mainly focused on detecting semantically related words rather than exact synonyms, by measuring the similarity of surrounding contexts. For example, these approaches may identify “beer” and “wine” as related words because both have similar surrounding words such as “drink”, “people”, “bottle”, and “make’. A different approach exploited WORDNET, a large lexical database for English words, to evaluate semantic similarity of any two concepts based on their distance to other concepts that subsume them in the taxonomy.

In the biomedical domain, most approaches for synonym identification appear to be restricted to the actual content of the strings in question, and ignore the surrounding context. One such approach uses a semi-automatic method to identify multi-word synonyms in UMLS (the Unified Medical Language System) by linking terms as candidate synonyms if they shared any words. For example, the term “cerebrospinal fluid” leads to “cerebrospinal fluid protein assay.” A different approach employs a trigram-matching algorithm to identify similar multi-word phrases. In this approach, the phrases are treated as documents made up of character trigrams. The “documents” are then represented in the vector space model, and similarity is computed as the cosine of the angle between the corresponding vectors. Several other approaches apply rule-based, statistical, or machine-learning approaches for mapping abbreviations to their full forms. These approaches, however, do not automatically identify synonymous relations among gene or protein, or other items having multiple names and/or abbreviations identifying them.

### SUMMARY OF THE INVENTION

The present invention generally provides methods, systems, and computer readable media having software stored thereon that when executed perform methods for extracting gene and/or protein synonyms from text by processing a plurality of documents making up a text corpus, tagging a plurality of terms, each term identifying at least one of a gene and a protein from the text corpus, and determining whether at least two of the tagged terms are synonyms identifying a common gene or protein using one or more of expert knowledge or machine learning techniques. Handcrafted extraction techniques are generally based on patterns derived from expert knowledge, whereas machine learning techniques are based on patterns recognized at least partially by machine. An unsupervised technique is provided that finds synonymous terms at least in part based on a set of known synonymous terms and patterns that describe the context where the known terms appears. A partially supervised technique is provided that finds terms synonymous at least in part based on a set of seed tuples comprising a set of terms known to be synonyms and on at least one set of tuples generated automatically based on the seed tuples. A supervised machine learning technique is also provided that finds terms synonymous at least in part based on a training set of contexts comprising words separating terms, wherein the training set is generated automatically based on a set of terms known to be synonyms and a set of terms known not to be synonyms.

Additional aspects of the present invention will be apparent in view of the description which follows.

### BRIEF DESCRIPTION OF THE FIGURES

FIG. 1 is a table that lists of top ranked synonyms in accordance with one embodiment of the invention.

FIG. 2 is a block diagram of an architecture for a partially supervised extraction technique, according to one embodiment of the invention.

FIG. 3 is a set of graphs that plot the precision of the various extraction techniques according to at least one embodiment of the invention.

### DETAILED DESCRIPTION OF THE INVENTION

Extracting gene and protein synonyms from text generally requires first identifying gene or protein names and/or abbreviations in the text, and then determining whether these names and/or abbreviations are synonymous. Synonymous gene and protein names and/or abbreviations, hereinafter names and/or abbreviations collectively referred to as “names”, generally represent the same biological substances, which may generally be recognized, for example, if the substances in question exhibit identical biological functions or have the same gene or amino acid sequences.

In one embodiment of the invention, extracting synonymous terms from a body of text begins by identifying or tagging the genes and proteins as they appear in the text. The task of tagging gene and protein names and abbreviations may be accomplished with a tagger program or module for pre-processing the text corpus, e.g., one or more items of biological literature, to identify the genes and/or proteins in the text corpus. Gene and protein identification may be accomplished with a variety known taggers.

In many instances, gene or protein synonyms occur within the same sentence. Accordingly, in one embodiment, the text corpus is segmented into sentences using a Sentence Splitter program or module. Pairs of genes that appear within the same sentence may then be considered as potential synonyms by any of the following extraction techniques. Additionally, gene and protein synonyms are typically specified in the first few pages of an article. Accordingly, in one embodiment, the system examines only a beginning portion of an article, e.g., the first 4 Kb of text of each article, for identification of potential synonyms.

Having identified the gene and protein names, one or more extraction techniques may then be applied to the tagged names for determining which of the names are synonyms of each other. The present invention generally provides four novel complementary approaches or systems for extracting synonymous gene and protein names from biological literature, including an unsupervised approach, a partially supervised approach, a supervised approach, and manually constructed system approach. A combined approach or system is also provided where the output of the manually constructed system approach is augmented with the output of the supervised approach. The approaches or systems are generally implemented in software stored on computer readable a medium or hardware, or a combination thereof, such as a computer device with software that when executed extracts synonymous gene and protein names from text.

The contextual similarity or unsupervised machine learning approach finds sets of words that appear in similar contexts. The main observation is that synonyms of a word can be detected by finding words that appear in the same contexts as t. If the contexts of t₁ and t₂ are similar, then t₁ and t₂ are considered synonyms. More formally, the context of a term t may be all words that occur within a d word window from t, e.g., d=5. In order to separate chance co-occurrence from the words that tend to appear together, in one embodiment the method uses mutual information to weight each word w in the context of t. In one embodiment, the mutual information I (t, w) is defined as log₂(P(t, w)/P(t)*P(w), and calculated as:

$$I ( t , w ) = {log}_{2} [ \frac{N}{d} \cdot \frac{freq ( t , w )}{freq ( t ) \cdot freq ( w )} ]$$

where N is the size of the corpus in words, and d is the size of the window. Note that I(t, w)≠I(w, t) because freq(t, w) (i.e., the number of times w appears to the right of t) is not symmetric. Using mutual information, the similarity Sim between two terms t₁ and t₂, may then be determined based on their respective contexts as:

$$\frac{{\sum }_{wflexicon} min ( I ( w , {t}_{1} ) , I ( w , {t}_{2} ) ) + min ( I ( {t}_{1} , w ) , I ( {t}_{2} , w ) ) }{{\sum }_{wflexicon} max ( I ( w , {t}_{1} ) , I ( w , {t}_{2} ) ) + max ( I ( {t}_{1} , w ) , I ( {t}_{2} , w ) ) }$$

where w ranges over the complete lexicon of all of the words that appear in the respective contexts of t₁ and t₂. The value of the similarity Sim(t₁ and t₂) may then be used to determine whether t₁ and t₂ are synonyms. The greater the similarity of course, the greater the possibility that the terms are synonyms.

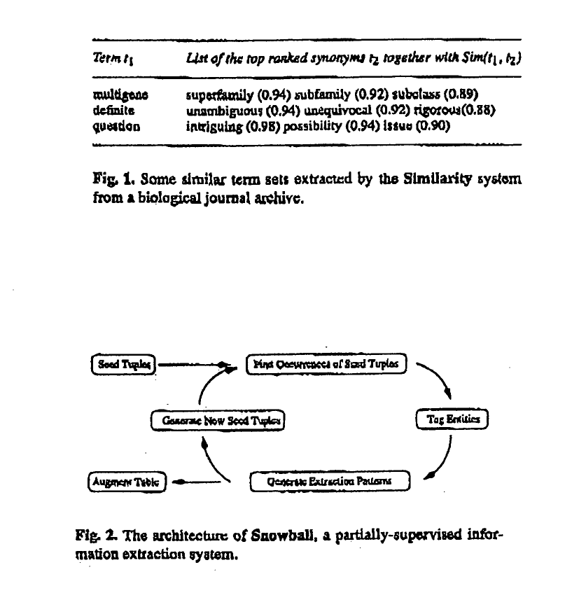

In certain instances, it may not be feasible to compute Sim(t₁, t₂) for all choices of t₁ and t₂ since this would require O(\lexicon\³) running time. In this instance, a heuristic search algorithm may be implemented to compute a close approximation of the set of most similar terms for a given term t₁. FIG. 1 reports some of the synonym sets extracted with the similarity approach from a text corpus made up of a biological journal archive. The confidence, Conf(s), of a candidate synonym pair s(g₁, g₂) is simply the value of similarity Sim(g₁, g₂). The top k most similar terms for each term g₁, e.g., set k=5, may generally be considered synonymous.

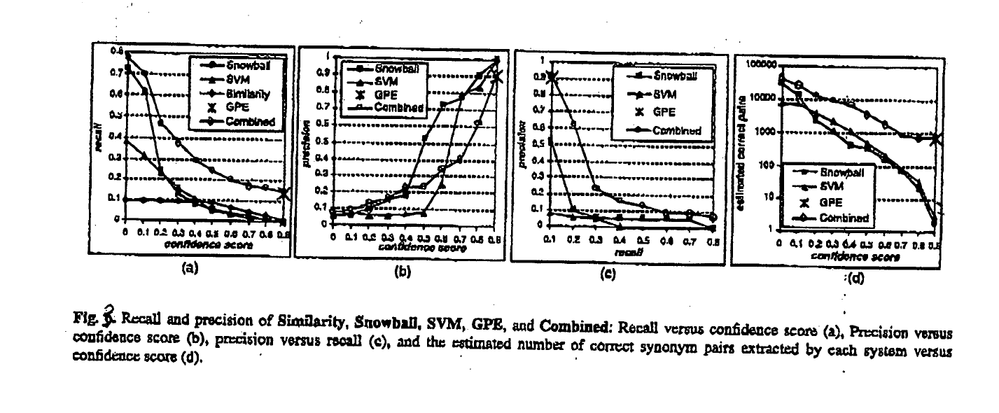

While the unsupervised approach may be attractive insofar as it does not require manual training, the extracted gene and protein pairs may be false positives. Accordingly, an approach incorporating some domain knowledge, which does not require significant manual effort, such as a partially supervised approach, may be used for synonym determinations. In one embodiment, the partially supervised machine learning approach or snowball approach uses a bootstrapping approach for extracting structured relations from unstructured (natural language) text. The partially supervised approach, as shown in FIG. 2, starts with a small set of user-provided seed tuples for the relation of interest, and automatically generates and evaluates patterns for extracting new tuples. The relation to be extracted is generally Synonym (Gene₁, Gene₂).

As initial input, the partially supervised system only requires a set of user-provided seed, e.g., example, tuples in the target relation, e.g., a set of known gene or protein synonym pairs. The partially supervised system also makes use of negative examples, e.g., co-occurring genes and protein expressions known not to be synonyms of each other. The partially supervised system then proceeds to find occurrences of the positive seed tuples in the collection, which are converted into extraction patterns that are subsequently used to extract new tuples from the documents. The process generally iterates by augmenting the seed tuples with the newly extracted tuples.

A crucial step in the extraction process is the generation of patterns to find new tuples in the documents. Given, a set of seed tuples (e.g., (g₁, g₂)), and having found the text segments where g₁ and g₂ occur close to each other, the partially supervised system may analyze the text that connects g₁ and g₂ to generate patterns. The partially supervised system's patterns incorporate entity tags, i.e., the GENE tags assigned by the tagger during the preprocessing. For example, a pattern would be generated from a context ‘(GENE) Oleo known as (GENE)’. The partially supervised system represents the left, middle, and right “contexts” associated with an extraction pattern as vectors of weighted terms (where terms can be arbitrary strings of non-space characters). During extraction, to match text portions with patterns, the partially supervised system also associates an equivalent set of term vectors with each document portion that contains two entities with the correct tags, i.e., a pair of GENES.

After generating patterns, the partially supervised system scans the collection to discover new tuples by matching text segments with the most similar pattern (if any). Each candidate tuple will then have a number of patterns that helped generate it, each with an associated degree of match. This information, together with information about the selectivity of the patterns, is used to decide what candidate tuples to actually add to the table that it is constructing. Intuitively, one can expect that newly extracted synonyms for ‘known’ genes should match the known synonyms for these genes. Otherwise, if the newly extracted synonym is “unknown”, i.e., a potential false positive, the pattern is considered to be less selective and its confidence is decreased. For example, if Snowball or the partially supervised system extracts a new synonym pair s=(gₐ, g_{b}), a check may be made to determine if there exists a set of high confidence previously extracted synonyms for gₐ, e.g., (gₐ, g₁), (gₐ, g₂). If g_{b} is equal to either g₁ or g₂, s is considered a positive match for the pattern, and an unknown match otherwise. Note that this confidence computation “trusts” tuples generated an earlier iteration more than newly extracted tuples. Additionally, if the pattern P matches a known negative example tuple, the confidence of P is further decreased. More formally, Snowball defines Conf(P), the confidence of a pattern P as:
log₂(Pₚₒₛᵢₜᵢᵥₑ)/(Pₚₒₛᵢₜᵢᵥₑ/(Pₚₒₛᵢₜᵢᵥₑ+P_{unknown}*wᵤₙₖ+P_{negative}*w_{neg}))
where Pₚₒₛᵢₜᵢᵥₑ is the number of positive matches for P, P_{unknown} is the number of ‘unknown’ matches, and P_{negative} is the number of negative matches, adjusted respectively by the wᵤₙₖ and w_{neg} weight parameters, which may be set during system tuning. The confidence scores may be normalized so that they are between 0 and 1.

The partially supervised system calculates the confidence of the extracted tuples as a function of the confidence values and the number of the patterns that generated the tuples. Intuitively, Conf (s), the confidence of an extracted tuple s, will be high if s is generated by several highly selective patterns. More formally, the confidence of s is defined as:

$$Conf ( s ) = 1 - {\prod }_{t = 0}^{/ P /} ( 1 - Conf ( {P}_{i} ) * Match ( {C}_{i} , {P}_{i} ) ) )$$

where P=(Pᵢ) is the set of extraction patterns that generated s, and Cᵢ is the context associated with an occurrence of s that matched Pᵢ with degree of match Match(Cᵢ, Pᵢ). After determining the confidence of the candidate tuples, the partially supervised system may discard all tuples with low confidence. These tuples could add noise into the pattern generation process, which would in turn introduce more invalid tuples, degrading the performance of the system. The set of tuples to use as the seed in the next iteration is then Seed={s/Conf(s)>tᵢ), where, in one embodiment, tᵢ:=0.6 as a threshold tuned during system development.

In one embodiment, a supervised machine or learning SVM approach or system is used to build a text classifier to identify synonymous genes and proteins. In this instance, the system is provided positive and negative example gene and protein pairs, similar to the partially supervised system, and a training set of example contexts where the gene and protein pairs occur is the then automatically created. These contexts are assigned either a positive weight of 1.0 or a negative weight of w_{neg}.

The classifier can then be trained to distinguish between the “positive” text contexts, i.e., those that contain an example synonym pair, and the “negative” text contexts. Thus, a classifier would be able to distinguish previously unseen text contexts that contain synonym pairs. e.g., A also known as B, from the contexts that do not express the synonymy relation, e.g., A regulates B. The classifier generally uses as features the same terms and term weights used by the partially supervised system for training and prediction. A radial basis kernel function option may also be used over the corpus.

After the classifier is trained, the supervised system examines every text context, C, surrounding pairs of identified gene and protein terms in the collection. If the classifier determines C to be an instance of the “positive”, i.e., synonym, class, the corresponding pair of genes or proteins, s, is assigned the initial confidence score Conf₀(s), equal to the score that the classifier assigned to C. The confidence scores may be normalized so that the final confidence of the candidate synonym pair s, Conf (s), is between 0 and 1. Note that classifier does not combine evidence from multiple occurrences of the same gene or protein pair when s occurs in multiple contexts, Conf (s) is assigned based on a single most promising text context of s.

A labor-intensive manual constructed system or handcrafted approach may also be built specifically for extracting synonymous gene and protein expressions. The construction of handcrafted system or GPE system begins with a set of known synonymous gene or protein names. The domain expert then examines the contexts where these example gene or protein pairs occur and manually generates patterns to describe these occurrences. For example, the expert decided that the strings “known as” and “also called” would work well as extraction patterns. Using these manually constructed patterns, the handcrafted system scans the collection for new synonyms. For example, the system may identify the synonymous set Apo3, LARD, DR3, wsl from the sentence ‘ . . . Apo3 (also known as LARD, DR3, and wal)’. Since the system does not use gene or protein taggers, many pairs of strings that are not genes or proteins can be extracted. To avoid such false positives, the classifier may use heuristics and knowledge-based filters to filter the non-gene or protein matches. After filtering, each extracted synonym pair s may be assigned a confidence Conf(s)=1.

While the handcrafted system requires labor-intensive tuning by a biology expert, it can extract a small high quality set of synonyms. In contrast, both the partially supervised and the supervised systems induce extraction patterns automatically, allowing them to capture synonyms that may be missed by handcrafted system. The partially supervised and the supervised systems, on the other hand, are also likely to extract more false positives, resulting in the lower quality of the extracted synonyms. In one embodiment, a combined system for extracting synonymous gene and protein names is provided that includes a knowledge-based and at least one machine learning-based techniques.

The outputs of the individual extraction systems may be combined in different ways. For the combined system, we assume that each system is an independent predictor, and that the confidence score assigned by each system to the extracted pair corresponds to the probability that the extracted synonym pair is correct. We can then estimate the probability that the extracted synonym pair s=(pi, p2) is correct as (1—the probability that all systems extracted s incorrectly):
Conf(s)=1−Π(1−Conf_{E}(s))
where Conf_{E}(s) is the confidence score assigned to s by the individual extraction system E. This combination function quantifies the intuition that agreement of multiple extraction systems on a candidate synonym pair s indicates that s is a true synonym.

We evaluated the unsupervised, partially supervised, supervised, handcrafted, and Combined over a collection of 52 000 recent journal articles from Science, Nature, Cell, EMBO, Cell Biology, PNAS, and the Journal of Biochemistry. The collection was separated into two disjoint sets of articles: the development collection, containing 20000 articles, and the test collection, containing 32000 articles.

System tuning. The unsupervised, partially supervised, supervised systems were tuned over the unlabeled development collection articles. The tuning consisted of changing the parameter values, e.g., the size of the context window d, in a systematic manner to find a combination that appeared to perform best on the development collection. The final parameter values used for the subsequent experiments over the test collection are listed in Table A.

TABLE A

| Parameter | Value | Description |
|---|---|---|
| window d | 5 | Size of text content (in words) to consider |
| \seed\ | 650 | Number of user-provided maniple pairs (for |
| | | Snowball and SVM) |
| \seed_{neg}\ | 28 | Number of negative user-provided example pairs |
| | | (for Snowball and SVM) |
| MaxIteraltions | 2 | Number of iterations (for Snowball) |
| w_{neg} | 2 | Relative weight of negative pattern matches (for |
| | | Snowball and SYM) |
| wᵤₙₖ | 0.1 | Relative weight of unknown pattern matches (for |
| | | Snowball) |

User-provided examples. Note that the machine-learning based systems do not require manually labeled articles. Instead, approximately 650 known gene and protein synonym pairs, previously compiled from a variety of sources, were used as positive examples for the partially supervised and supervised systems. Some of these did not occur in the collections, and thus did not contribute to the system training. Additionally, a set of negative examples was compiled by a biology expert by examining the contexts of some commonly co-occurring, but not synonymous, genes and proteins in the development collection.

One of the goals of our evaluation is to determine whether the extraction approaches that we compare generalize to new document collections. Therefore, the only information that we retained from the tuning of the systems were the values of the system parameters (shown in Table A). During the test stage of our experiments, both the partially supervised and supervised systems were trained from the unlabeled articles in the test collection, by starting with the same initial example gene and protein pairs described above.

Our evaluation focuses on the quality of the extracted set of synonym pairs, Se: (1) how comprehensive is Se, and (2) how clean the pairs in Se are. To compare the alternative extraction systems, we adapt the recall and precision metrics from information extraction. Recall, generally refers to the fraction of all of the synonymous gene and protein pairs that appear in the collection, Sₐₗₗ, and were captured in the extracted set, Se. Precision, refers to the fraction of the real synonym pairs in Se. Note that all of the compared extraction systems assign a confidence score between 0 and 1 to each extracted synonym pair. It would be useful to know the precision of the systems at various confidence levels. Therefore, we calculate precision at c, where c is the threshold for the minimum confidence score assigned by the extraction system. The precision at c is the precision of the subset of the extracted synonyms with the confidence score greater than or equal to c. Recall at c is equivalent.

TABLE B
Four types of apparent gene and protein relationships that were designated
by SWISSPROT as synonyms: Family Related, Subunit, Homologous, and
Functionally Related.

| Relationship | SWISSPROT | |
|---|---|---|
| Type | Synonyms | Context |
| Family Related | GRPE, MGEL | ‘. . .requires the nucleotide release |
| | | factors, grpe and mgel. . . |
| Fragment | PS2, ALC3 | ‘. . .sas ps-2 c-terminal-1O9-amino |
| | | and fragment (alg3) is essential in |
| | | the death process. . .’ |
| Subunits | P40, P38 | ‘. . .baculoviruses encoding indiv- |
| | | idual rf-c subunits p140, p40, p38, |
| | | p37, and p36) yielded. . .’ |
| Homologous | GRIP-1, TIF2 | ‘. . .shown that grip-1, the murine |
| | | homologous of tif2. . .’ |
| Functionally | CDC47, MCM2 | ‘and cdc47, cdc21, and mis5 form |
| Related | | another complex, which relatively |
| | | weakly associates with mcm2’ |

For small text collections, we could inspect all documents manually and compile the sets of all of the synonymous genes in the collection by hand. Unfortunately, this evaluation approach does not scale, and becomes infeasible for the kind of large document collections for which automatic extraction systems would be particularly useful. The problem with exhaustive evaluation is two-fold: (1) the ex-traction systems tend to generate many thousands of synonyms from the collection (which makes it impossible to examine all of them to compute precision), and (2) since modern collections typically contains thousands of documents, it is not feasible to examine all of them to compute recall. To estimate precision at c, for each system's output Se we randomly select 20 candidate synonym pairs from Se with confidence scores (0.0-0.1, 0.1-0.2, . . . , 0.9-1.0). As a result, each system's output is represented by a sample of approximately 200 synonym pairs. Each sample (together with the supporting text context for each extracted pair) was given to two biology experts to judge the correctness of each extracted pair in the sample. Having computed the precision of the extracted pairs for each range of scores, we estimate precision at c as the average of the evaluated precision scores for each confidence range, weighted by the number of extracted tuples within each confidence score range.

To compute the exact recall of a set of extracted synonym pairs Se we would need to manually process the entire document collection to compile all synonyms in the collection. Clearly, this is not feasible. Therefore, we used a set of known correct synonym pairs that appear in the collection, which we call the GoldStandard. To create this GoldStandard, we use SWISSPROT. From this well structured database, we generate a table of synonymous gene and protein pairs by parsing the ‘DE’ and ‘GN’ sections of protein profiles. Unfortunately, we cannot use this table as is, since some, of the pairs may not occur at all in our collection. We found that synonym expressions tend to appear within the same sentence. Therefore, the GoldStandard consists of synonymous genes and proteins (as specified by SWISSPROT) that co-occur in at least one sentence in the collection, and were recognized by the tagger. We found a total of 989 such pairs.

Unfortunately, we found that we did not agree with many of these synonym pairs. We consider synonymous gene or protein names to be those that represent the scone genes or proteins. However, SWISSPROT appears to consider a broader range of synonyms. For example, SWISSPROT synonyms included different genes or proteins that had a similar function, that belong to the same family, that were different subunits, and those that were functionally related as shown in Table B. Note that we judged the synonym pairs based solely on the information in our corpus and did not perform any biological experiments.

To create the GoldStandard, we asked six biology experts to evaluate gene and protein pairs listed as synonyms in SWISSPROT, and judge whether they considered the pairs as synonyms. Each expert evaluated between 100 to 989 pairs. Each candidate synonym pair was judged by at least two experts, and was included in the GoldStandard if at least one of the experts agreed with the SWISSPROT classifications. Experts disagreed with SWISSPROT on 318 pairs, and were unsure of additional 83. As a result, we included a total of 588 confirmed synonym pairs in the GoldStandard. The agreement was 0.61 among experts, 0.83 between experts and SWISSPROT, and 0.77 overall. The resulting GoldStandard is used to estimate recall as the fraction of the GoldStandard synonym pairs captured.

### Results

In this section we compare the performance of the unsupervised or Similarity, partially supervised or Snowball, supervised or SVM, handcrafted or GPE, and Combined systems on the recall and precision metrics over the test collection described above. Table C shows the running time through the test collection using a dual-CPU 1.2 Ghz Athlon machine with 2 Gb of RAM.

TABLE C

| System | Tagging | Similarity | Snowball | SVM | GPE |
|---|---|---|---|---|---|
| Time | 7 hours | 40 minutes | 2 hours | 1.5 hours | 35 minutes |

FIG. 3a reports recall of all systems. Similarity performs poorly, with recall less than 0.09 for all confidence scores. In contrast, Snowball and SVM have the highest recall for confidence scores below 0.4 (reaching 0.72 for Snowball and 0.38 for SVM), while GPE has the best recall (0.14) of any individual system for the higher confidence scores. Note that GPE always assigned the Conf (s)=1 to all extracted candidate pairs, and is therefore represented by a single data point in each plot. Combined has the highest recall of all systems for all confidence scores. For example, at confidence score c=0.4, Combined recall is more than double that of any individual system.

We report the precision of all systems for varying confidence scores in FIG. 3b. Similarity has extremely low precision (less than 0.01) and therefore is not shown. Our experiments indicate that Similarity performed well for more common terms (FIG. 1), but performed poorly on identifying gene and protein synonyms as it tends to extract pairs of genes that are related, but not synonymous. Both Snowball and SVM extract synonyms with over 0.9 precision at their highest confidence scores. GPE also has the precision of 0.9. The confidence scores that both Snowball and SVM assign to their extracted pairs are correlated with the actual precision. For example, while the precision at c=0.8 of Snowball is 0.9, precision at c=0.1 is 0.1. Snowball has higher precision than SVM for all confidence score values. Also note that while both Snowball and SVM have sharp drops in precision between the confidence scores of 0.4 and 0.7, the Combined confidence score is more smooth, and appears to be a better predictor of the precision.

FIG. 3c reports the values of precision versus recall for all systems. Both Snowball and SVM clearly trade off precision for high recall. Even though Snowball is able to achieve the recall of almost 0.72, the corresponding precision is 0.07. In contrast, GPE has at most 0.14 re-call. As we conjectured, combining these complementary approaches in Combined resulted in a significant gain. While Combined has the highest precision of all systems, it is also able to achieve the highest recall of 0.8.

To complement the reported recall figures, we also estimated the number of all real synonym pairs extracted by each system for each confidence score c (FIG. 3d). These values were calculated by multiplying the number of pairs extracted by the system with the score>c by the corresponding precision at c. Despite exhibiting lower precision values, Snowball and SVM extract a significantly larger set of real synonyms than GPE. Similarly, Combined extracts the largest estimated number of real synonyms. For example, we estimate Combined to have extracted almost 10,000 correct synonyms at the confidence score of 0.4, which is more than ten times the estimated number of synonyms extracted by Snowball, SVM, or GPE individually. In summary, Combined is the best performing system on all metrics, and significantly improves over the manually constructed GPE.

We evaluated the four different extraction approaches over a large collection of biological journal articles. Our extraction results are particularly valuable as we found that many of the synonyms that we extracted do not appear in SWISSPROT. Of the 148 extracted synonym pairs that were manually judged as correct by the experts during our evaluation, 62 (or 42%) were not listed as synonyms in SWISSPROT. This leads us to predict that out of the approximately 10,000 correct synonym pairs extracted by Combined with confidence score>0.4 (FIG. 3d), we would find more than 4000 novel synonym pairs.

Our results show that machine learning-based approaches were responsible for the significant improvement of Combined over the manually constructed knowledge-based system. Snowball and SVM are—by design—more flexible, and therefore can detect cases on which GPE failed. For example, Snowball extracted the pair (EIF4G, P220) from the text fragment: “. . . eIF4G also known as e1F4 or p220, binds both e1F4A . . . ”, which was not captured by GPE. While both SVM and Snowball contributed to the improved performance of Combined, Snowball has an additional advantage of generating intuitive human-readable patterns that can be potentially examined and filtered by a domain expert.

Our approaches extract synonyms from a collection of biological literature, and therefore the quality of the extracted relation depends in part on the collection consistency. We found some conflicting statements in our collections. For example, the following two statements are taken from two different articles in our test collection: while the first text fragment suggests that the proteins PC1 and PC3 are different substances, another article indicates that PC1 and PC3 are synonyms for the same substance: ‘the positive cofactors (pcs) pc1, pc2, pc3, and p15.; and ‘ . . . hydra pc1 (also called pc3) . . . ’ Additional information may be used to make a decision whether PC1 and PC3 are synonyms.

While the foregoing invention has been described in some detail for purposes of clarity and understanding, it will be appreciated by one skilled in the art, from a reading of the disclosure, that various changes in form and detail can be made without departing from the true scope of the invention in the appended claims.

1. A method for extracting at least one of gene and protein synonyms from text comprising:
processing a plurality of documents making up a text corpus;
tagging a plurality of terms, each tern identifying at least one of a gene and a protein from the text corpus; and
determining whether at least two of the tagged terms are synonyms identifying a common gene or protein.

2. The method of claim 1, wherein the text corpus comprises a plurality of items of biological literature.

3. The method of claim 1, wherein the terms identifying at least one of a gene and a protein comprises a name and an abbreviation.

4. The method of claim 1, wherein synonymous terms are recognized if tagged terms at least one of exhibits identical biological functions and has the same gene or amino acid sequences.

5. The method of claim 1, comprising segmenting the text corpus into sentences and determining whether at least two of the tagged terms are synonyms based at least in part on whether the tagged terms appear in the same sentence.

6. The method of claim 1, comprising processing only a beginning portion of each of the plurality of documents that make up the corpus.

7. The method of claim 1, wherein the step of determining whether tagged terms are synonyms is accomplished using an unsupervised extraction technique that finds terms synonymous at least in part based on the context in which the terms are used.

8. The method of claim 7, wherein the context is limited to words occurring within a predefined number of words from the tagged term.

9. The method of claim 8, wherein mutual information regarding the words occurring within the predefined number of words from the tagged term is used to compute a similarity between tagged terms and wherein the computed similarity is used for determining whether terms are synonymous.

10. The method of claim 9, comprising computing a set of synonymous terms being most similar based on the computed similarity.

11. The method of claim 1, wherein the step of determining whether tagged terms are synonyms is accomplished using a partially supervised extraction technique that finds terms synonymous at least in part based on a set of seed tuples comprising a set of terms known to be synonyms and on at least one set of tuples generated automatically based on the seed tuples.

12. The method of claim 11, wherein the seed tuples comprises terms known not to be synonyms.

13. The method of claim 11, wherein tuples are generated automatically based at least in part on context patterns generated from text found in text segments separating the seed tuples.

14. The method of claim 13, comprising computing a confidence score based on the generated context patterns for at least one set of tuples and determining whether the set of tuples comprises synonymous terms based on the confidence score.

15. The method of claim 1, wherein the step of determining whether tagged terms are synonyms is accomplished using a supervised machine learning extraction technique that finds terms synonymous at least in part based on a training set of contexts comprising words separating terms, wherein the training set is generated automatically based on a set of terms known to be synonyms and a set of terms known not to be synonyms.

16. The method of claim 15, wherein the contexts are each assigned a positive or a negative weight, and wherein whether terms are determined to be synonymous based on context weight.

17. The method of claim 1, wherein the step of determining whether tagged terms are synonyms is accomplished using a handcrafted extraction technique that finds synonymous terms at least in part based on a set of known synonymous terms and patterns that describe the context where the known terms appears.

18. The method of claim 17, comprising filtering non-protein and non-gene synonyms.

19. The method of claim 1, wherein the step of determining whether tagged terms are synonyms is accomplished using a handcrafted extraction technique and at least one extraction technique selected from the group consisting of:
an unsupervised technique that finds synonymous terms at least in part based on a set of known synonymous terms and patterns that describe the context where the known terms appears,
a partially supervised technique that finds terms synonymous at least in part based on a set of seed tuples comprising a set of terms known to be synonyms and on at least one set of tuples generated automatically based on the seed tuples, and
a supervised machine learning technique that finds terms synonymous at least in part based on a training set of contexts comprising words separating terms, wherein the training set is generated automatically based on a set of terms known to be synonyms and a set of terms known not to be synonyms.

20. A method for extracting at least one of gene and protein synonyms from text comprising:
processing a plurality of documents making up a text corpus comprises a plurality of items of biological literature;
tagging a plurality of terms, each term identifying at least one of a gene and a protein from the text corpus, wherein the terms identifying at least one of a gene and a protein comprises a name and an abbreviation; and
determining whether at least two of the tagged terms are synonyms identifying a common gene or protein.

21. A method for extracting at least one of gene and protein synonyms from text comprising:
processing a plurality of documents making up a text corpus;
tagging a plurality of terms, each term identifying at least one of a gene and a protein from the text corpus; and
determining whether at least two of the tagged terms are synonyms identifying a common gene or protein using a handcrafted extraction technique based on expert knowledge and at least one machine learning extraction technique selected from the group consisting of:
an unsupervised technique that finds synonymous terms at least in part based on a set of known synonymous terms and patterns that describe the context where the known terms appears,
a partially supervised technique that finds terms synonymous at least in part based on a set of seed tuples comprising a set of terms known to be synonyms and on at least one set of tuples generated automatically based on the seed tuples, and
a supervised machine learning technique that finds terms synonymous at least in part based on a training set of contexts comprising words separating terms, wherein the training set is generated automatically based on a set of terms known to be synonyms and a set of terms known not to be synonyms.
